(19) United States
(12) Patent Application Publication
(10) Pub. No.: US 2014/0192168 A1
(43) Pub. Date: Jul. 10, 2014

(54) IMAGE PROCESSING DEVICE, METHOD, AND STEREOSCOPIC IMAGE DISPLAY DEVICE

(71) Applicant: KABUSHIKI KAISHA TOSHIBA, TOKYO (JP)

(72) Inventors: Kenichi SHIMOYAMA, Tokyo (JP); Nao Mishima, Tokyo (JP); Takeshi Mita, Yokohama-shi (JP); Ryusuke Hirai, Tokyo (JP)

(73) Assignee: KABUSHIKI KAISHA TOSHIBA, TOKYO (JP)

(21) Appl. No.: 14/147,835

(22) Filed: Jan. 6, 2014

(30) Foreign Application Priority Data
Jan. 9, 2013 (JP) 2013-001739

(51) Int. Cl. H04N 13/04; H04N 13/02

(52) U.S. Cl. CPC H04N 13/0445; H04N 13/0203
USPC 348/50

(57) ABSTRACT

According to an embodiment, an image processing device provides a stereoscopic image to be displayed on a display and includes an acquisition unit, first and second calculators, a selector, and a determiner. The acquisition unit acquires observer information. The first calculator calculates, a viewpoint vector pointing from one to another of the observer position of each observer and the display, and an eye vector pointing from one to another eye of the observer, based on the observer information. The second calculator calculates a weight indicating a degree of desirability of stereoscopic viewing for each observer when the stereoscopic image according to one of display parameters is displayed on the display) by using the viewpoint vector and the eye vector of the observer. The selector selects one display parameter based on the weight. The determiner determines the stereoscopic image according to the selected display parameter.

### CROSS-REFERENCE TO RELATED APPLICATIONS

This application is based upon and claims the benefit of priority from Japanese Patent Application No. 2013-001739, filed on Jan. 9, 2013; the entire contents of which are incorporated herein by reference.

### FIELD

Embodiments described herein relate generally to an image processing device, a method, a computer program product, and a stereoscopic image display device.

### BACKGROUND

In related art, a stereoscopic image display device to be horizontally placed which allows stereoscopic viewing from all around has been known. For example, a technique is known according to which, in order to allow each of a plurality of observers surrounding a table or the like to observe a stereoscopic image, a mirror surface or a wall surface is provided between a plurality of pixels arrayed on a and so that light from only limited (predetermined) pixels is transmitted in each of the surrounding directions.

However, with the technique in the related art, there is an issue that the configuration is complicated because a mirror surface or a wall surface has to he provided between pixels.

### BRIEF DESCRIPTION OF THE DRAWINGS

FIG. 1 is a diagram illustrating a stereoscopic image display device of an embodiment seen from above;

FIG. 2 is a diagram illustrating the stereoscopic image display device of the embodiment seen from the side;

FIG. 3 is a schematic diagram of the stereoscopic image display device of the embodiment;

FIG. 4 is a diagram illustrating an example configuration of a display of the embodiment;

FIG. 5 is a diagram for describing a parallax number assigned to each parallax image of the embodiment;

FIG. 6 is a diagram illustrating as example configuration of an image processor of the embodiment;

FIG. 7 is a diagram for describing a condition of stereoscopic viewing of the embodiment;

FIG. 8 is a schematic diagram of a viewing region and a pseudoscopic region of the embodiment;

FIG. 9 is a diagram for describing a condition of stereoscopic viewing of the embodiment;

FIG. 10 is a schematic diagram of a viewing region and a pseudoscopic region of the embodiment;

FIG. 11 is a diagram for describing a viewing region parameter of the embodiment;

FIG. 12 is a diagram for describing a viewing parameter of the embodiment;

FIG. 13 is a diagram for describing viewing regions of the embodiment that are adjacent to each other;

FIG. 14 is a diagram illustrating examples of control of a viewing region based on the pitch of an array of pixels of the embodiment;

FIG. 15 is a diagram showing samples of control of a viewing region based on movement, rotation and change in shape of the display of the embodiment;

FIG. 16 is a diagram for describing a light beam parameter;

FIG. 17 is a diagram for describing a calculation method of a second weight of the embodiment;

FIG. 18 is a diagram for describing a calculation method of a third weight of the embodiment;

FIG. 19 is a flow chart illustrating an example of a process of the image processor of the embodiment; and

FIG. 20 is a diagram illustrating an example configuration of a capturing unit of an example modification.

### DETAILED DESCRIPTION

According to an embodiment, an image processing device provides a stereoscopic image to be displayed on a display. The device includes an acquisition unit, a first calculator, a second calculator, a selector, and a determiner. The acquisition unit acquires observer information including a position of at least one observer. The first calculator calculates, a viewpoint vector pointing from one to another of the position of the observer and the display and an eye vector pointing from one eye to another eye of the observer, based on the observer information. The second calculator calculates a weight indicating a degree of desirability of stereoscopic viewing for each observer when the stereoscopic image according to one of display parameters is displayed on the display, by using the viewpoint vector and the eye vector of the observer. The selector selects one of the display parameters based on the weight. The determiner determines the stereoscopic image according to the selected display parameter.

Hereinafter, a embodiment will b described in detail with reference to the appended drawings. The stereoscopic image display device of an embodiment below may adopt a 3D display method such as an integral imaging method (an II method) or a multi-view method, for example. A stereoscopic image is an image including a plurality of parallax images having a parallax to each other, and parallax is a difference in the way an object is seen due to being seen from different directions. An image in the embodiment is any of a still image and a moving image.

A stereoscopic image display device 100 according to the present embodiment includes a display 10 having an image display plane P on which a stereoscopic image is displayed.

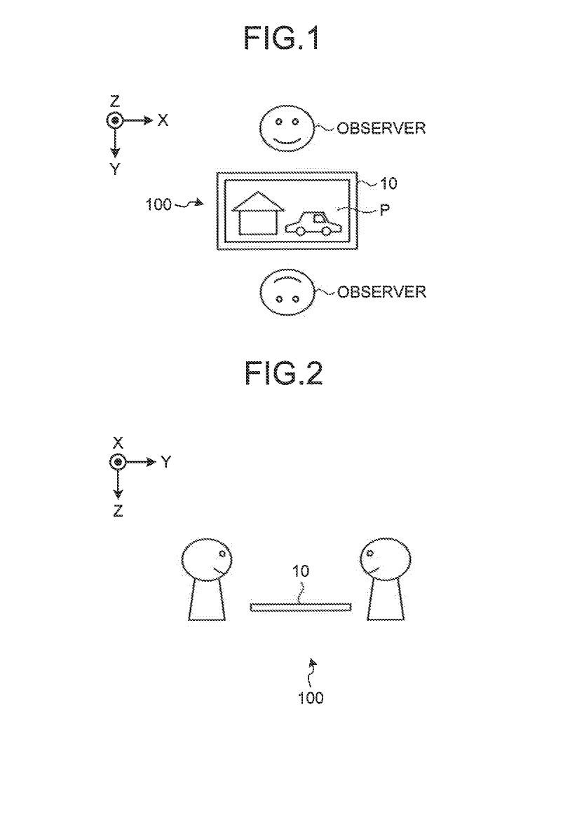

This display 10 is placed such that the image display plane P is parallel to the horizontal plane. More specifically, the display 10 is placed such that the image display plane P and the horizontal plane whose normal direction coincides with the vertical direction (the gravity direction) are parallel to each other. Additionally, the parallelism of the image display plane P and the horizontal plane may mean not only a case where the image display plane P and the horizontal plane are perfectly parallel to each other, but also a case where the image display plane P and the horizontal plane are substantially parallel to each other. That is, the stereoscopic image display device 100 is a stereoscopic image display device to be horizontally placed. FIG. 1 is a schematic diagram illustrating the stereoscopic image display device 100 seen from above in the vertical direction. FIG. 2 is a schematic diagram illustrating the stereoscopic image display device 100 seen from the side. Here, the vertical direction is set as a Z axis, the left/right direction orthogonal to the Z axis on the horizontal plane parallel to the image display plane P is set as an X axis, and the vertical direction orthogonal to the X axis on the horizontal plane is set as a Y axis, but the way the coordinate system is set is not limited to this.

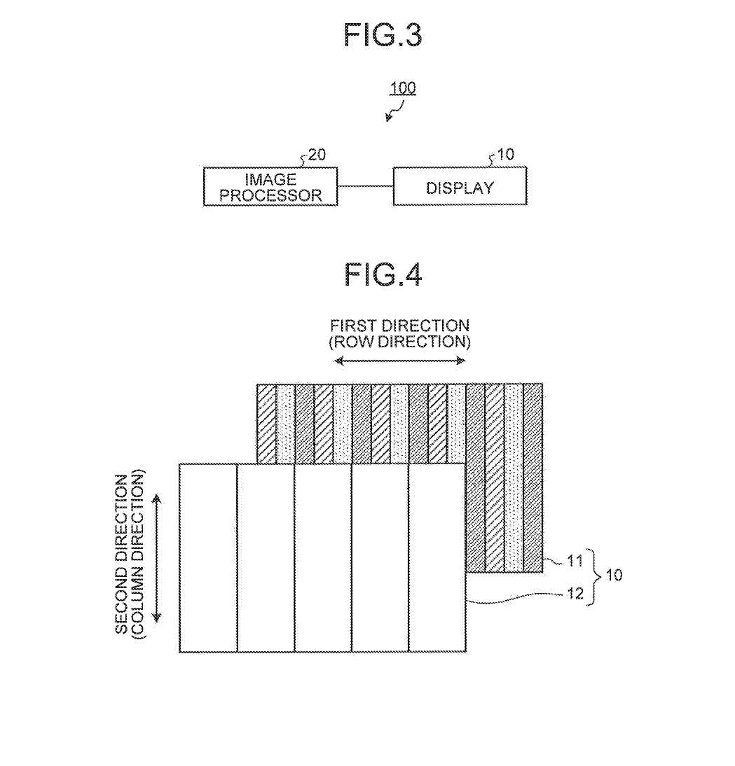

FIG. 3 is a schematic diagram of the stereoscopic image display device 100 of the present embodiment. As illustrated in FIG. 3, the stereoscopic image display device 100 includes a display 10, and an image processor 20. The display 10 is a device for displaying a stereoscopic image including a plurality of parallax images having a parallax to each other. As illustrated in FIG. 4, the display 10 includes a display element 11, and a light beam control element 12.

Parallax images are images used for allowing an observer to observe a stereoscopic image, and are each an image constituting the stereoscopic image. In the stereoscopic image, pixels of each parallax image are assigned such that, when the display element 11 is observed from the viewpoint position of an observer through the light beam control element 12, one parallax image is observed by one eye of the observer, and another parallax image is observed by the other eye. That is, the stereoscopic image is generated by rearranging the pixels of each parallax image.

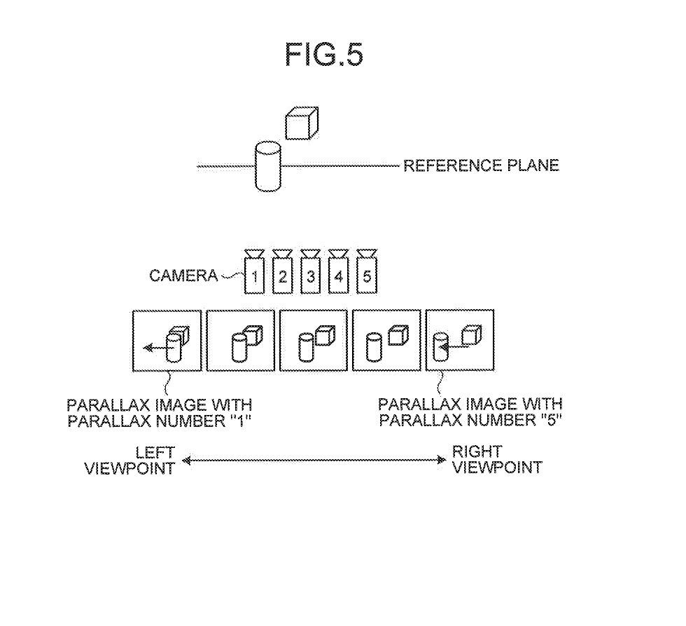

Now, a parallax number assigned to each parallax image b described. For example, a case where the number of parallaxes is “5” is considered. In this example, as illustrated in FIG. 5, five cameras (viewpoints) are arranged at specific intervals, and the parallax number of the parallax image corresponding to a camera 1 at the leftmost position is given as “1”, and as a camera gets closer to the rightmost position, the parallax number of the parallax image corresponding to this camera is increased, and the parallax number of the parallax image corresponding to a camera 5 at the rightmost position is given as “5”. That is, in the present embodiment, the larger the parallax number is, the parallax image to which the parallax number is assigned corresponds to a viewpoint that is more to the right.

Referring back to FIG. 4 description will be given. The display element 11 displays a stereoscopic image. The display element 11 is a liquid crystal panel on which a plurality of subpixels having color components (for example, R, G and B) are arranged in a matrix, in a first direction for example, the row direction in FIG. 4) and in a second direction (for example, the column direction in FIG. 4), in this case, the subpixels of respective colors, R, G and B, arranged in the first direction constitute one pixel. The arrangement of subpixels on the display element 11 may be other known arrangements. Also, the subpixels are not limited to the three colors, R, G and B. For example, there may be four or more colors.

Furthermore, as the display element 11, a direct-view two-dimensional display, an organic EL (Organic Electro Luminescence) display, an LCD (Liquid Crystal Display), a POP (Plasma Display Panel), a projection display or the like may be used. Also, the display element 11 may include a backlight.

The light beam control element 12 controls the light beam emission direction of each subpixel of the display element 11. There is a certain distance (gap) between the light beam control element 12 and the display element 11. The light beam control element 12 has optical apertures for emitting light beams that are linearly extended, and the optical apertures are arranged in the first direction. As the light beam control element 12, a lenticular sheet where a plurality of cylindrical, lenses are arranged or a parallax barrier where a plurality of slits are arranged may be used, for example. Moreover, the light, beam control element 12 may he configured such that the optical apertures are arranged with the extension direction having a specific inclination to the column direction (the second direction) of the display element 11 (a tilted-lens configuration).

The optical aperture is arranged in correspondence to each element image of the display element 11. Here, one pixel is constituted from subpixels of respective colors, R, G and B, arranged in the first direction, and an image displayed by a pixel group where adjacent pixels, equal to the number of parallaxes, are arranged in the first direction is called an element image. The element image may be said to be an image including each of the pixels of a plurality of parallax images. Here, a set of element images displayed on the display 10 (the display element 11) constitutes a stereoscopic image. When a plurality of element images are displayed on the display element 11, image light beams corresponding to a plurality of parallax directions pass through respective optical apertures of the light beam control element 12. Then, an observer positioned in a viewing region (a region where a stereoscopic image can be observed) is to observe different pixels included in the element images (pixels of different parallax images) by the left and right eyes. In this manner, by presenting images with different parallaxes to the left and right eyes of an observer, the observer is enabled to stereoscopically perceive (stereoscopically view) the stereoscopic image displayed on the display 10.

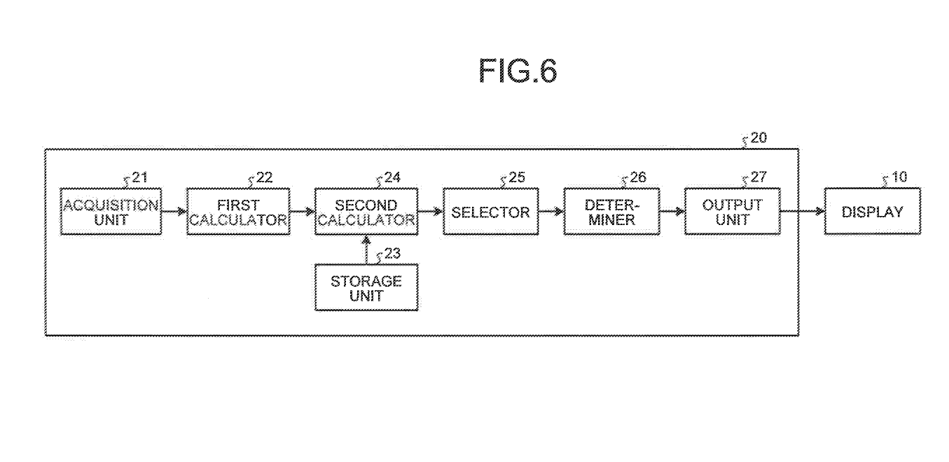

Next, the image processor 20 illustrated in FIG. 3 will be described. The image processor 20 determines the stereoscopic image to be displayed on the display 10 that is capable of displaying a plurality of parallax images having a parallax to each other as a stereoscopic image. In this example, the image processor 20 corresponds to an “image processing device” in the claims. FIG. 6 is a diagram illustrating an example configuration of the image processor 20. As illustrated in FIG. 6, the image processor 20 includes an acquisition unit 21, a first calculator 22, a storage unit 23, a second calculator 24, a selector 25, a determiner 26, and an output unit 27.

The acquisition unit 21 acquires observer information including the position of at least one observer (user). In the present embodiment, the acquisition unit 21 includes a capturing unit (for example, a camera) for capturing a specific space including a position assumed to be an observation position for a stereoscopic image, and a detector for detecting (identifying) the position of one or more observers from an image (a captured image) captured by the capturing unit, and is capable of acquiring the observer information including the position of one or more observers detected by the detector. For example, the observer information may include information indicating the orientation of the face of one or more observers. In this case, the detector serves the function of detecting the orientation of the face of one or more observers in the captured image.

Alternatively, a mode is also possible where the acquisition unit 21 does not include the capturing unit and the detector, and the observer information detected by the detector is held by an external device (for example, a server device) or a memory, not illustrated, for example. In this case, the acquisition unit 21 may acquire the observer information by accessing the external device (for example, the server device) or the memory, not illustrated.

The first calculator 22 calculates, a viewpoint vector pointing from one to another of the position of each observer (each observer in the captured image) and the display 10, and an eye vector pointing from one eye to another eye of the observer, based on the observer information acquired by the acquisition unit 21. For example, the first calculator 22 may calculate the eye vector and the viewpoint vector of each observer based on the position of each observer included in the observer information. The eye vector and the viewpoint vector of each observer calculated by the first calculator 22 are transmitted to the second calculator 24.

The storage unit 23 stores therein a plurality of types of display parameters for providing the stereoscopic image to be displayed on the display 10. The display parameters include a pixel parameter for variably setting the arrangement of the pixels of the stereoscopic image to be displayed on the display 10 (a parameter for changing the arrangement of pixels for each display parameter), a viewing region parameter for controlling the viewing region, a light beam parameter for controlling the light beam density indicating the density of light beams to be emitted from each pixels, and the like.

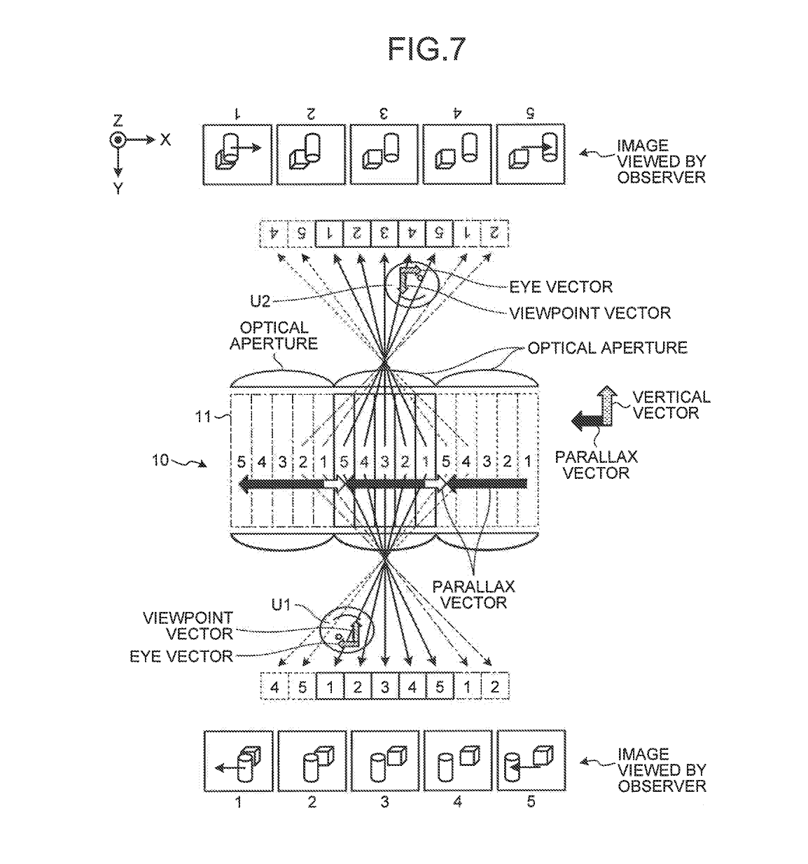

Now, a condition for an observer existing around the display 10 that is placed on the horizontal plane of a desk or the like, for example, to be able to observe the stereoscopic image displayed on the display 10 (a condition of stereoscopic viewing) will be described. Here, as an example, a case will be described where a stereoscopic image whose number or parallaxes is “5” is displayed on the display 10, as illustrated in FIG. 7. The numbers illustrated in FIG. 7 represent the parallax images corresponding to the numbers.

In the example of FIG. 7, a pixel parameter is set such that, among a pixel group (an element image) arranged facing one optical aperture of the light beam control element 12, the first pixel from the left is assigned with a pixel whose parallax number is “5”, the second pixel from the left is assigned with a pixel whose parallax number is “4”, the third pixel from the left is assigned with a pixel whose parallax number is “3”, the fourth pixel from the left is assigned with a pixel whose parallax number is “2”, and the fifth pixel from the left (the pixel at the right end of the element image) is assigned with a pixel whose parallax number is “1”.

In the present embodiment, the viewpoint vector pointing from one to the other of the position of an observer and the display 10 is as vector pointing from the position of the observer toward the display 10, and in the case the direction of the viewpoint vector is the upward direction from the horizontal plane that is parallel to the image display plane P (the direction from the positive side to the negative side in the Y direction in FIG. 7), the direction or the viewpoint vector is defined to be positive. Furthermore, in the present embodiment, the vertical vector indicating the direction, in the vertical direction, of a parallax image included in a stereoscopic image is a vector indicating the upward direction of the parallax image, and in the case the direction of the vertical vector is the upward direction from the horizontal plane (the direction from the positive side to the negative side in the Y direction in FIG. 7), the direction of the vertical vector is defined to be positive. In the example in FIG. 7, the pixel parameter is set such that the direction of the vertical vector of each parallax image included in the stereoscopic image displayed on the display 10 is positive for any parallax image.

Furthermore, in the present embodiment, a parallax vector indicating the amount of parallax between parallax images is a vector indicating, based on a parallax image corresponding to the left eye of an observer (hereinafter, sometimes referred to as a parallax image for a left eye), the amount of parallax between the parallax image for a left eye and a parallax image corresponding to she right eye of she observer (hereinafter, sometimes referred to as a parallax image for a right eye), and in the case the direction of the parallax vector indicates the direction from right to left on the horizontal direction (the leftward direction in FIG. 7), the direction of the parallax vector is defined to be positive. Furthermore, in the present embodiment, the eye vector pointing from one eye to the other eye of an observe is a vector pointing from the right, eye to the left eye, and in the case the direction of the eye vector Indicates the direction from right to left on the horizontal plane, the direction of the eye vector is defined to be positive.

According to the definitions given above, in the case the product of a first inner product indicating the inner product of the viewpoint vector and the vertical vector and a second inner product indicating the inner product of the parallax vector and the eye vector takes a positive value, the condition of the stereoscopic viewing is established, and an observer is allowed to observe a stereoscopic image. However, even if the product of the first inner product and the second inner product takes a positive value, if the value of the first inner product is negative, a stereoscopic image for which the direction of the vertical direction is reversed is observed by the observer (a stereoscopic image in an up-side-down state is observed).

It is noted that the definitions of the eye vector, the vertical vector, the parallax vector, and the viewpoint vector are not limited to those of the present embodiment described above. For example, the viewpoint vector may be defined to be a vector pointing from the display 10 to the position of an observer. The vertical vector may be defined to be a vector indicating the downward direction of a parallax image. Moreover, the parallax vector may be defined to be a vector indicating the parallax, based on the parallax image for a right eye of an observer, from the parallax image for a right eye to the parallax image for a left eye. Furthermore, the eye vector may be defined to be a vector pointing from the left eye to the right eye of an observer.

Furthermore, the definitions as described above and the definitions in the present embodiment may be arbitrarily combined. In short, regardless of how the eye vector, the vertical vector, the parallax vector, and the viewpoint vector are defined, an observer is allowed to observe a stereoscopic image only when a condition equivalent to the condition described above (that the product of the first inner product indicating the inner product of the viewpoint vector and the vertical vector and the second inner product indicating the inner product of the parallax vector and the eye vector takes a positive value under the definitions in the present embodiment) is established.

FIG. 7 will be further described. First, an observer U1 existing on the lower side, on the horizontal plane, of the display 10 (on the positive side in the Y direction in. FIG, 7) will be described. The direction of the viewpoint vector pointing from the position of the observer U1 to the display 10 is an upward direction on the horizontal plane (the direction from the positive side to the negative side in the Y direction in FIG. 7), and thus, the direction of the viewpoint, vector of the observer U1 is positive. Furthermore, with respect to the vertical vector of the observer U1, a vertical, vector of a parallax image whose area is the greatest when the display 10 is observed from the position of the observer U1 is considered. As described above, in the example in FIG. 7, she directions of the vertical vectors of the parallax images included in the stereoscopic image displayed on the display 10 are all positive, and thus, the direction of the vertical vector of the observer U1 is positive. Accordingly, the first inner product indicating the inner product of the viewpoint vector and the vertical vector of the observer U1 takes a positive value.

Furthermore, as illustrated in FIG. 7, on the horizontal plane, the left eye of the observer U1 is positioned on the left side of the right eye. The parallax image corresponding to the left eye of the observer U1 is a parallax image whose parallax number is “1”, and the parallax image corresponding to the right, eye is a parallax image whose parallax number is “2”, and the direction of the parallax vector indicating the amount of parallax from the parallax image corresponding to the left eye to the parallax image corresponding to the right eye is the direction from right to left (the leftward direction in FIG. 7). Accordingly, the direction of the parallax vector of the observer U1 is positive. Furthermore, the direction, of the eye vector pointing from the right, eye of the observer U1 to the left eye indicates the direction from right to left on the horizontal plane, and thus, the direction of the eye vector of the observer U1 is positive. Accordingly, the second inner product indicating the inner product of the parallax vector and the eye vector of the observer U1 takes a positive value.

As described above, with respect to the observer U1, the product of the first inner product indicating the inner product of the eye vector and the vertical vector, and the second inner product indicating the inner product of the parallax vector and the eye vector takes a positive value. Accordingly, the observer U1 is able to observe the stereoscopic image displayed on the display 10. Furthermore, with respect to the observer U1, the first inner product indicating the inner product of the eye vector and the vertical vector takes a positive value, and the observer U1 is able to observe a stereoscopic image with the correct vertical direction.

Next, an observer U2 existing on the opposite side, on the horizontal plane, from the observer U1 across the display 10 (existing on the upper side of the display 10) will be described. As illustrated in FIG. 7, the direction of the viewpoint vector pointing from the position of the observer U2 to the display 10 indicates the downward direction on the horizontal plane (the direction from the negative side to the positive side in the Y direction in FIG. 7), and thus, the direction of the viewpoint vector of the observer U2 is negative. With respect to the vertical vector of the observer U2, a vertical vector of a parallax image whose area is the greatest when the display 10 is observed from the position of the observer U2 is considered. As described above, in the example in FIG. 7, the directions of the vertical vectors of the parallax images included in the stereoscopic image displayed on the display 10 are all positive, and thus, the direction of the vertical vector of the observer U2 is positive. Accordingly, the first inner product indicating the inner product of the viewpoint vector and the vertical, vector of the observer U2 takes a negative value.

As illustrated in FIG. 7, in contrast to the observer U1, on the horizontal plane, the left eye of the observer U2 is positioned on the right side of the right eye. Moreover, the parallax image corresponding to the left eye of the observer U2 is a parallax image whose parallax number is “5”, and the parallax image corresponding to the right eye is a parallax image whose parallax number is “4”, and the direction of the parallax vector indicating the amount of parallax from the parallax image corresponding to the left eye to the parallax image corresponding to the right eye is the direction from right to left (the leftward direction in FIG. 7). Accordingly, the direction of the parallax vector of the observer U2 is positive. Also, in the example in FIG. 7, the direction of the eye vector pointing from the right eye of the observer U2 to the left eye indicates the direction from left to right on the horizontal plane, and thus, the direction of the eye vector of the observer U2 is negative. Accordingly, the second inner product indicating the inner product of the parallax vector and the eye vector of the observer U2 cakes a negative value,

As described above, with respect to the observer U2, since the product of the first inner product indicating the inner product of the viewpoint vector and the vertical vector, and the second inner product indicating the inner product of the parallax vector and the eye vector is a product of negative values, the product of the first inner product and the second inner product takes a positive value, and the condition of stereoscopic viewing is satisfied. Accordingly, the observer U2 is able to observe the stereoscopic image displayed on the display 10. However, with respect to the observer U2, the first inner product indicating the inner product of the viewpoint vector and the vertical, vector takes a negative value, and the observer U2 is to observe a stereoscopic image whose vertical direction is reversed.

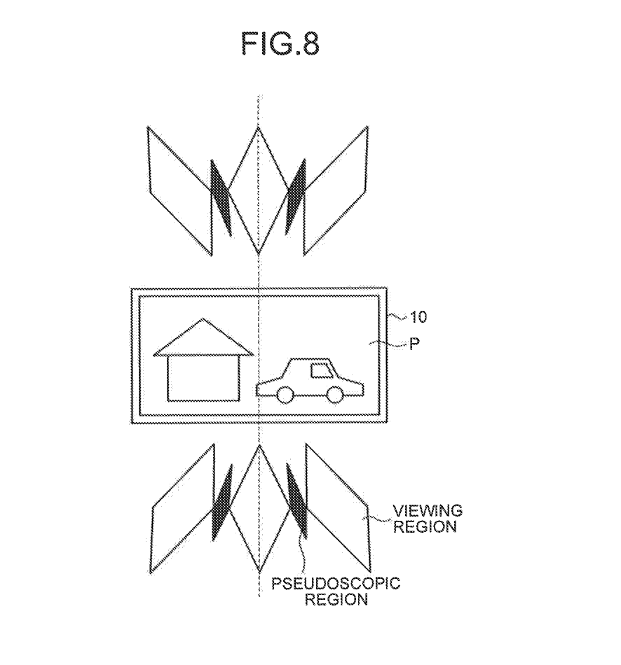

FIG. 8 is a schematic diagram illustrating a viewing region and a pseudoscopic region (a region where a stereoscopic image cannot be observed) where the arrangement of pixels of the display 10 is set as in FIG. 7 As illustrated in FIG. 8, a viewing region and a pseudoscopic region occur symmetrically across the display 10.

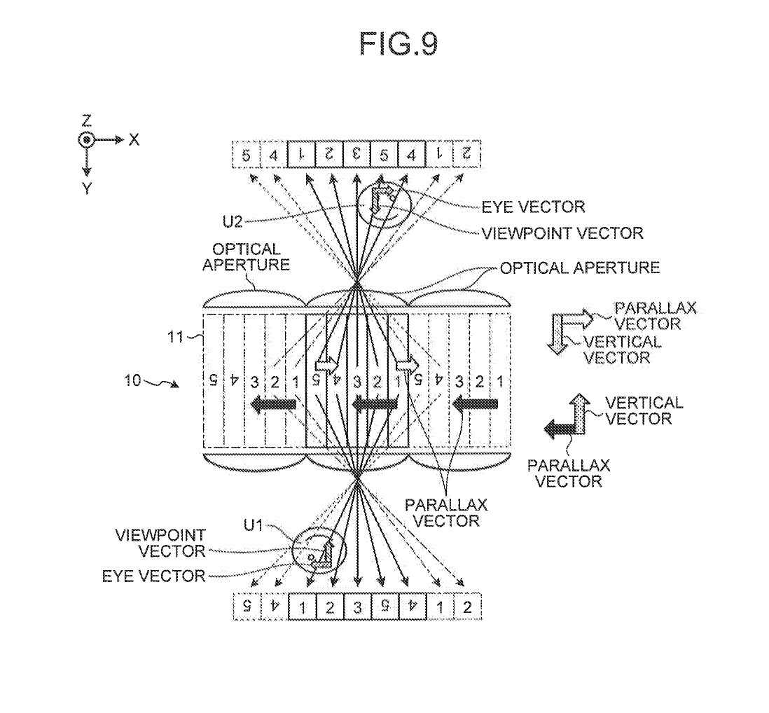

Next, as illustrated in FIG. 9, a case where the five parallax images illustrated in FIG. 7 are partially switched will be described as an example. In the example in FIG. 9, a pixel parameter is set so that the pixels are arranged in such a way that a vertically reversed parallax image whose parallax number is “5” is assigned to the position where a parallax image whose parallax number is “4” is assigned in FIG. 7, and a vertically reversed parallax image whose parallax number is “4” is assigned to the position where a parallax image whose parallax number is “5” is assigned in FIG. 7. In this example, the vertical vectors indicating the upward directions of the parallax image whose parallax number is “4” and the parallax image whose parallax number is “5” indicate downward direction on the horizontal plane (the direction from the negative side to the positive side in the Y direction in FIG. 9), and thus, the directions of the vertical vectors of the parallax image whose parallax number is “4” and the parallax image whose parallax number is “5” are negative.

In FIG. 9, the positions of the observer U1 and the observer U2 are the same as in the case in FIG. 7. With respect to the observer U1, the directions of the eye vector, the vertical vector, the parallax vector, and the viewpoint vector are the same as in the case in FIG. 7. Accordingly, also in the case in FIG. 9, the observer U1 is able to view a stereoscopic image with the correct vertical direction.

Next, description will be given on the observer U2. The direction of the viewpoint vector of the observer U2 is negative as in the case in FIG. 7. With respect to the vertical vector of the observer U2, a vertical vector of a parallax image whose area is the greatest when the display 10 is observed from the position of the observer U2 is considered. In the example in FIG. 9, the parallax image whose area is the greatest when the display 10 is observed from the position of the observer U2 is the vertically reversed parallax image whose parallax number is “4” or the vertically reversed parallax image whose parallax number is “5”. The upward direction of the vertically reversed parallax image whose parallax number is “4” or the vertically reversed parallax image whose parallax number is “5” is the downward direction on the horizontal plane, and thus, the direction of the vertical, vector of the observer U2 is negative. Accordingly, the first inner product indicating the inner product of the viewpoint vector and the vertical vector of the observer U2 takes a positive value.

As illustrated in FIG. 9, the parallax image corresponding to the left eye of the observer U2 is the vertically reversed parallax image whose parallax number is “4”, and the parallax image corresponding to the right eye is the vertically reversed parallax image whose parallax number is “5”, and the direction of the parallax vector indicating the amount of parallax from the parallax image corresponding to the left eye to the parallax image corresponding to the right eye is the direction from left to right (the rightward direction in FIG. 9). Accordingly, the direction of the parallax vector of the observer U2 is negative. Furthermore, the direction of the eye vector of the observer U2 is negative as in the case in FIG. 7. Accordingly, the second inner product indicating the inner product of the parallax vector and the eye vector of the observer U2 takes a positive value.

As described above, with respect to the observer U2, since the product of the first inner product indicating the inner product of the viewpoint vector and the vertical vector, and the second inner product indicating the inner product of the parallax vector and the eye vector is a product of positive values, the product of the first inner product and the second inner product takes a positive value, and the condition of stereoscopic viewing is satisfied. Accordingly, the observer U2 is able to observe the stereoscopic image displayed on the display 10. Furthermore, unlike the case in FIG. 7, since the first inner product indicating the inner product of the viewpoint vector and the vertical vector indicates a positive value, the observer U2 is able to observe a stereoscopic image with the correct vertical direction.

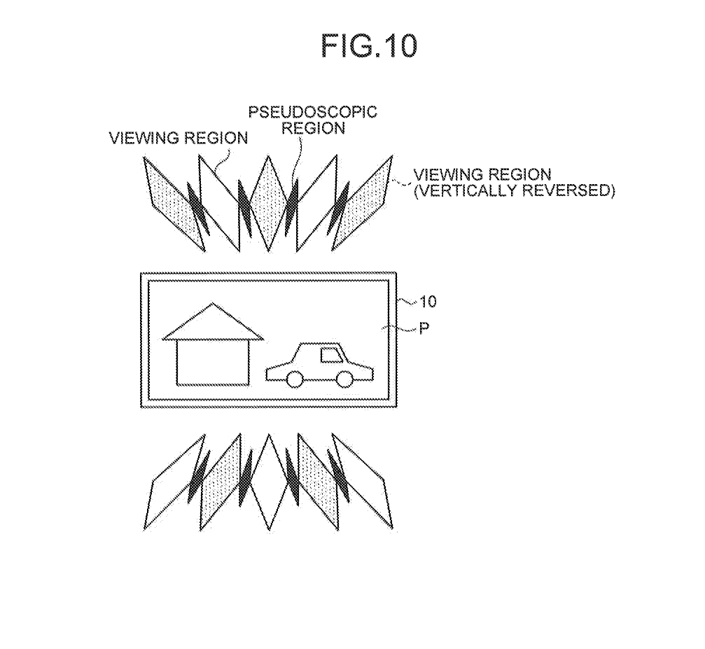

FIG. 10 is a schematic diagram of illustrating a viewing region and a pseudoscopic region where the arrangement of the pixels of the display 10 is set as in FIG. 9. As illustrated in FIG. 10, a viewing region and a pseudoscopic region occur symmetrically across the display 10. The viewing region indicated by halftone dots in FIG. 10 is a region where an observer is able to observe a vertically reversed stereoscopic image.

As described above, whether an observer existing around the display 10 that is placed on the horizontal plane of a desk or the like, for example, is able to observe an stereoscopic image displayed on the display 10 changes depending on the pixel parameter, in the present embodiment, each of a plurality of display parameters stored in the storage unit 23 includes a different pixel parameter. That is, the arrangement of the pixels of a stereoscopic image is set so as to be different for each display parameter.

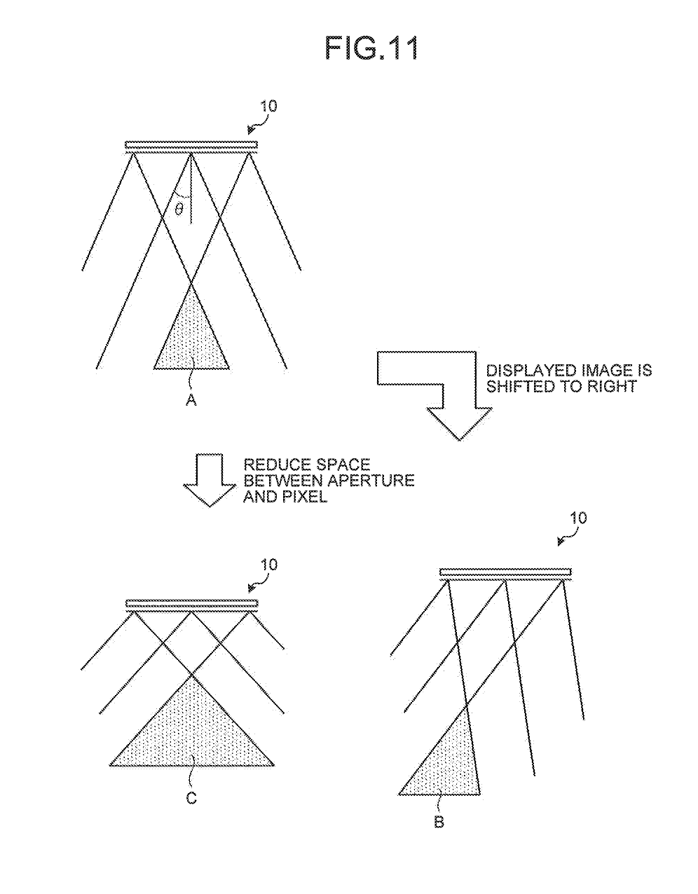

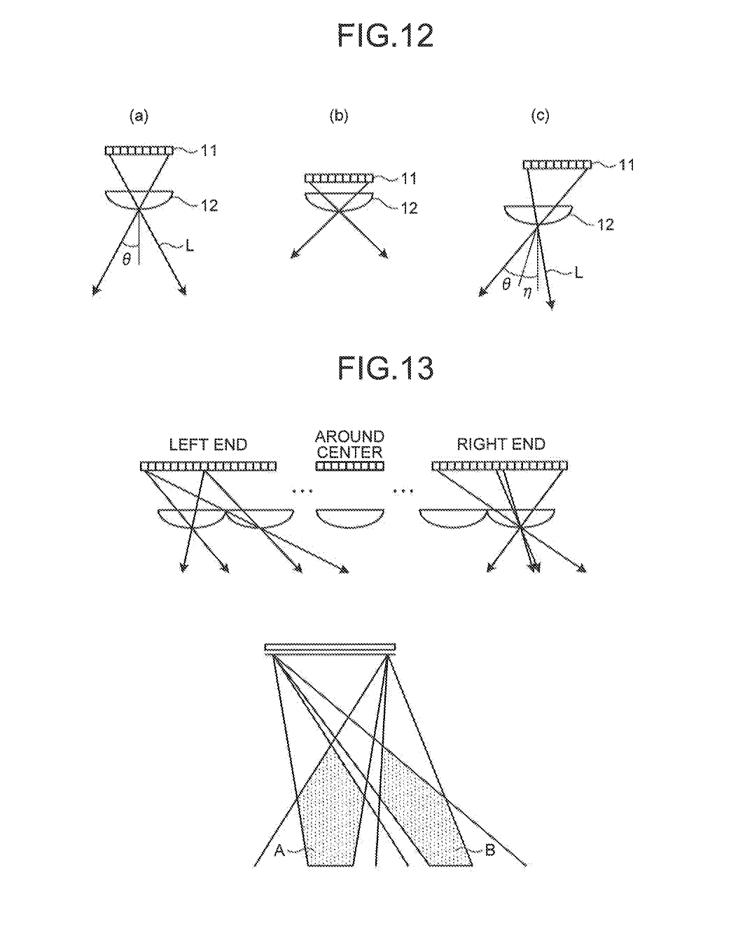

Next, a viewing region parameter included in the display parameter will be described. As a viewing region parameter, there may be the shifting of an image, the pitch of pixels, the space (gap) between the lens and pixels, or rotation, change in shape or movement, of position of the display 10 is display), for example. In the following, the viewing region parameter will be described with reference to FIGS. 11 and 12. When a display image is shifted to the right, for example, a position where desirable stereoscopic viewing is enabled, that is, the “viewing region”, changes from a viewing region A to a viewing region B illustrated in FIG. 11. As can be seen by comparing section (a) of FIG. 12 and section (c) of FIG, 12, this is due to a light beam. L moving to the left in section. (c) of FIG. 12, and the viewing region moving to the left, as a result, to become the viewing region B.

As can be seen by comparing section (a) of FIG. 12 and section (b) of FIG. 12, when the space between the display element 11 and the light beam control element 12 is reduced, the viewing region A changes to a viewing region C as illustrated in FIG. 11. In this case, the viewing region becomes close, but the light beam density is reduced.

The light beam from each of a plurality of pixels (subpixels) arranged on the display element 11 is emitted through the optical aperture corresponding to the pixel. The shape of the viewing region may be geometrically determined by θ and η illustrated in FIG. 12.

Referring to FIG. 13, viewing regions that are adjacent to each other will be described. A viewing region B adjacent to a viewing region A where stereoscopic observation is mainly performed is a viewing region formed from a combination of “a pixel at the left end, a lens second to the right from the left end” and “a pixel second to the left from the right end, a lens at the right end”. This viewing region B may be moved further to the left or to the right.

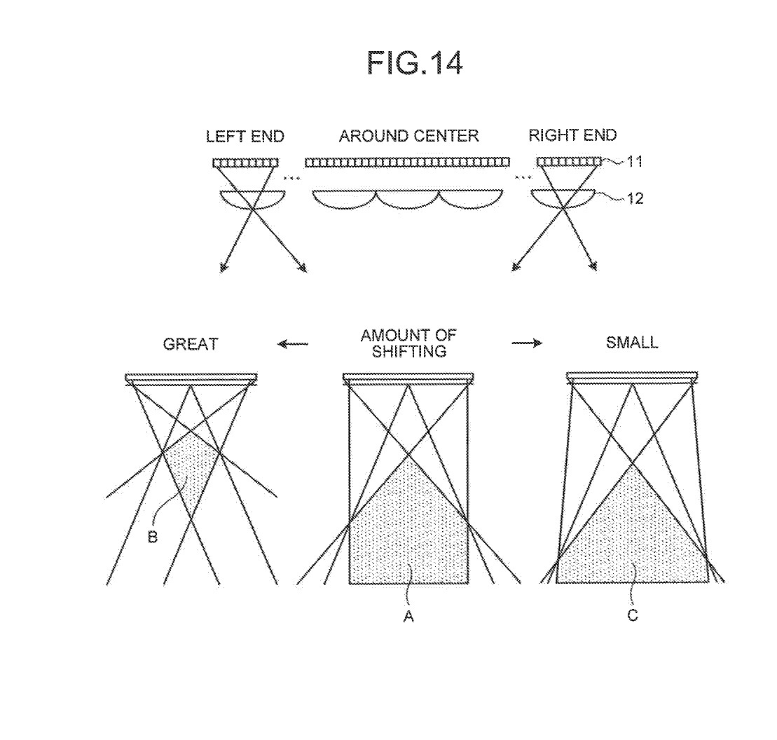

Referring to FIG. 14, control of a viewing region based on the arrangement of pixels to be displayed (a display pitch) will be described. A viewing region may be control by relatively shifting the positions of the display element 11 and the light beam control element 12, the degree of shifting being greater as it is closer to the end (the right end, the left end) of the screen. When the amount of shifting of the relative positions of the display element 11 and the light beam control element 12 is increased, the viewing region changes from a viewing region A to a viewing region B illustrated in the drawing. On the other hand, when the amount of shifting of the relative positions of the display element 11 and the light beam control element 12 is reduced, the viewing region changes from the viewing region A to a viewing region C illustrated in the drawing. In this manner, the width or distance of a viewing region may be controlled based on the pitch of the arrangement of the pixels. The position where the width of a viewing region is the greatest is referred to as a viewing region setting distance.

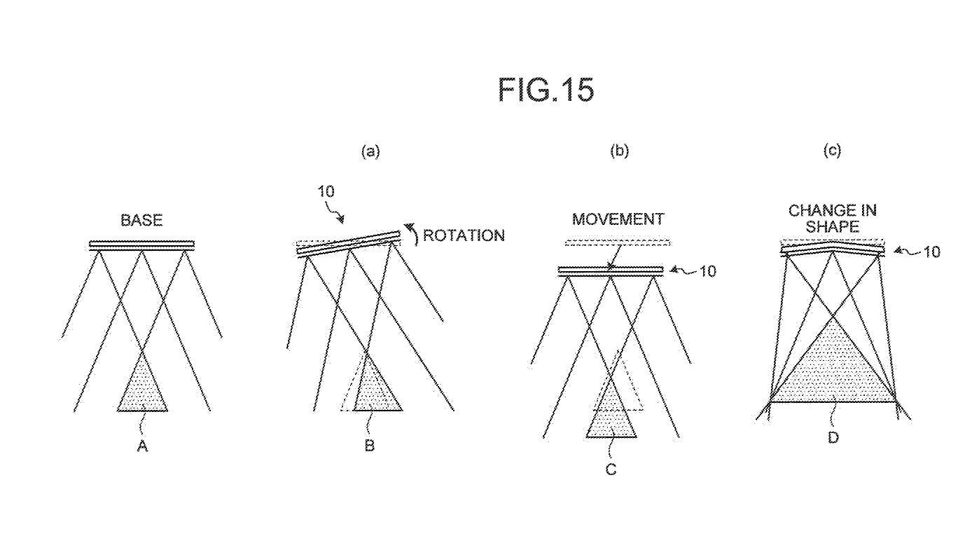

Next, referring to FIG. 15, control of a viewing region by movement, rotation, or change in shape of the display 10 will be described. As illustrated in section (a) of FIG. 15, a viewing region A, which is the basic region, may be changed to a viewing region 3 by rotating the display 10. In the same manner, the viewing region A, which is the basic region, may be changed to a viewing region C by moving the display 10, and the viewing region A, which is the basic region, may be changed to a viewing region D by changing the shape of the display 10. Information specifying the state of movement, rotation, or change in shape of the display 10 may be included as a viewing region parameter, for example, and a viewing region is determined according to the information.

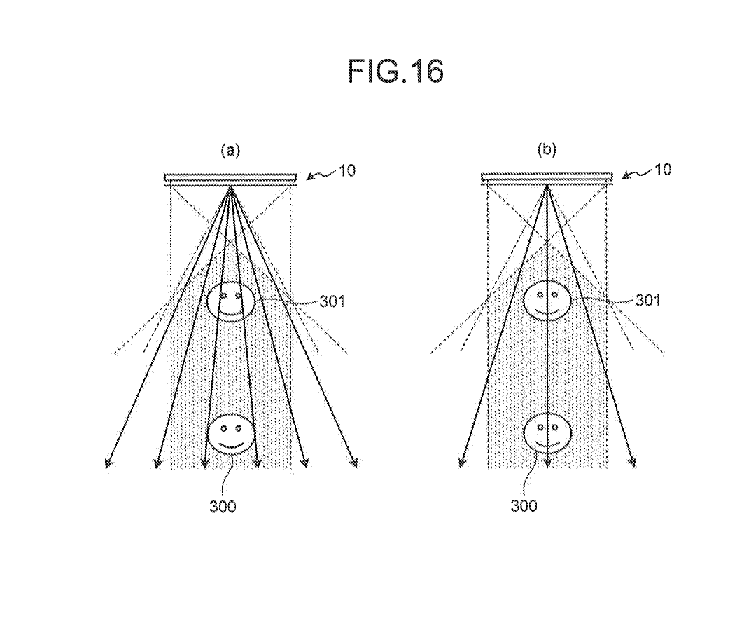

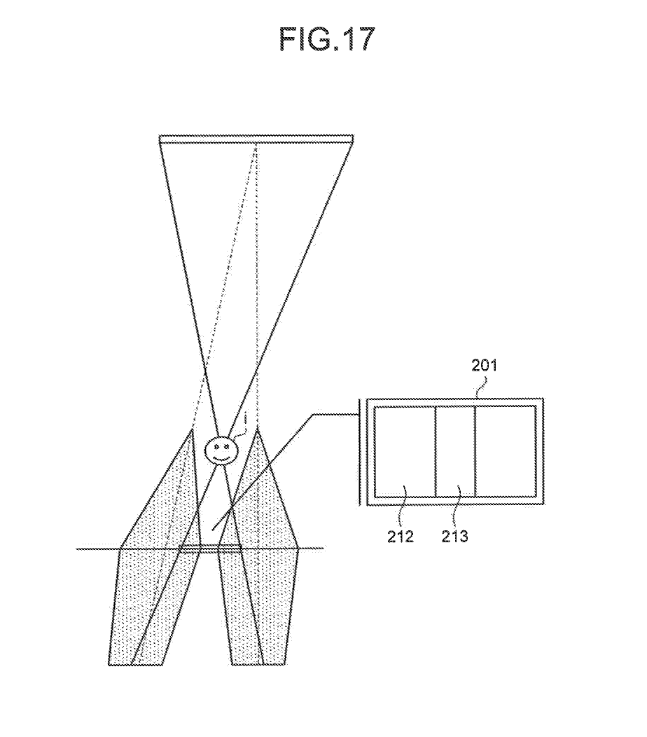

Next, referring to FIG. 16, a light beam parameter will be described. For example, in the case the number of parallaxes is “6” as illustrated in section (a) of FIG. 16, the number of light beams for providing parallax is greater, and thus, stereoscopic viewing is more desirable, for an observer 301 who is relatively closer to the display 10 than an observer 300, as can be seen from the drawing. Here, for the sake of convenience of description, a case will be described as an example where the display 10 is arranged with the image display plane P facing (opposing to) the observer 300 and the observer 301. As illustrated in section (b) of FIG. 16, in the case the number of parallaxes is “3”, the number of parallaxes is less and the light beams are more sparse than those in the case in section (b) of FIG. 16, and stereoscopic viewing at the same distance becomes difficult. The light beam density of light beams emitted from the pixels of the display 10 may be calculated based on an angle θ that is determined according to the lens or the space, the number of parallaxes, and the position of an observer. The position of an observer is acquire& by the acquisition unit 21, and a light beam parameter includes information specifying the angle θ that is determined according to the lens or the space and the number of parallaxes, for example.

In the present embodiment, the first inner product and the second inner product of an observer may be identified using a display parameter including a pixel parameter, and an eye vector and a viewpoint vector of the observer. It is noted that, in the present embodiment, the display parameter includes a pixel parameter, a viewing region parameter, and a light beam parameter, but this is not restrictive, and a mode of including other parameters, and a mode of not including the viewing parameter or the light beam parameter are also possible. Here, it is sufficient that the display parameter includes at least the pixel parameter.

Referring back to FIG. 6, description will be given. The second calculator 24 calculates a weight indicating the degree of desirability of stereoscopic viewing for each observer when a stereoscopic image according to one of display parameters is displayed on the display 10, by using an eye vector and a viewpoint, vector of the observer. More specifically, when a viewpoint vector and an eye vector of each observer are received from the first calculator 22, the second calculator 24 calculates, for each observer, the weight indicating the degree of desirability of stereoscopic viewing when a stereoscopic image according to a display parameter is displayed on the display 10, for each of a plurality of types of display parameters stored in the storage unit 23 and by using the viewpoint vector and the eye vector of each observer. This weight takes a greater value in the case the relationship of the direction, of the viewpoint vector and the direction of the vertical vector, and the relationship of the direction of the parallax vector and the eye vector satisfy a specific condition (a condition of stereoscopic viewing) than in a case where the specific condition is not satisfied. More specific details are as follows.

As described above, in the present embodiment, in the case the direction of the viewpoint vector pointing from the position of an observer to the display 10 indicates the upward direction on the horizontal plane, the direction of the viewpoint vector is defined to be positive, in the case the direction of the vertical vector indicating the upward direction of a parallax image indicates the upward direction on the horizontal plane, the direction of the vertical vector is defined to be positive. The direction of the parallax vector, based on a parallax image for a left eye, indicating the amount of parallax between the parallax image for a left eye and a parallax image for a right eye indicates the direction from right to left on the horizontal plane (the leftward direction), the direction of the parallax vector is defined to be positive. In the case the direction of the eye vector pointing from the right eye to the left eye of an observer indicates the direction from right, to left on the horizontal plane, the direction of the eye vector is defined to be positive, in the case the product of the first inner product indicating the inner product of the viewpoint vector and the vertical vector and the second inner product indicating the inner product of the parallax vector and the eye vector takes a positive value under the definitions above, the specific condition mentioned above (the condition of stereoscopic viewing) is satisfied.

In the present embodiment, the value of a weight is a value according to the product of the first inner product and the second inner product. More specifically, the second calculator 24 calculates, for each observer, based on one display parameter among a plurality of display parameters stored in the storage unit 23 and the eye vector and the viewpoint vector of each observer, a first weight according to the product of the first inner product and the second inner product, a second weight according to the area of a region allowing stereoscopic viewing at a position of the observer, and a third weight according to the light beam density at the position of she observer, and calculates the weight of the observer based on the first weight, the second weight, and the third weight. Then, weight information indicating information associating the weight of each observer and the display parameter used in the calculation of the weight is transmitted to the selector 25. In this example, the second calculator 24 transmits, to the selector 25, the same number of pieces of weight information as the number of display parameters stored in the storage unit 23.

Now, a calculation method of the first weight will be described. A first weight wᵢ of an observer i may be expressed by the following Equation (1).

wᵢ=(\vec{e}ᵢ·\vec{d}ᵢ)×(\vec{v}ᵢ·\vec{t}ᵢ) (1)

In Equation (1) above, vᵢ represents the viewpoint vector, tᵢ represents the vertical vector, eᵢ represents the eye vector, and dᵢ represents the parallax vector. As expressed by Equation (1) above, in the present embodiment, the first weight wᵢ is expressed by the product of the first inner product indicating the inner product of the viewpoint vector vᵢ and the vertical vector tᵢ and the second inner product indicating the inner product of the parallax vector dᵢ and the eye vector eᵢ. Thus, in the case the observer i is capable of stereoscopic viewing, the first weight wᵢ is a positive value, and the greater the value of the first weight wᵢ, the more desirable stereoscopic viewing is (the degree of desirability of stereoscopic viewing is increased).

Furthermore, even if the observer i is capable of stereoscopic viewing, the first weight wᵢ may be changed depending on whether a stereoscopic image with the correct vertical direction may be observed or not. For example, in the case it is possible to observe a stereoscopic image with the correct vertical direction, the value of the first weight wᵢ may be set to be greater compared to a case where a vertically reversed stereoscopic image is observed. In this case, the first weight wᵢ may be expressed by the following Equation (2).

ᵢ₂={(\vec{e}ᵢ·\vec{d}ᵢ)×(\vec{v}ᵢ·\vec{t}ᵢ) if (\vec{v}ᵢ·\vec{t}ᵢ)>0 (\vec{e}ᵢ·\vec{d}ᵢ)×(\vec{v}ᵢ·\vec{t}ᵢ)×α otherwise (2)

In Equation (2) above, the range of α is 0≦α<1. In Equation (2) above, it is indicated the evaluation is lowered in the case the vertical direction of the image is reverse of the correct direction.

Next, the second weight will be described with reference to FIG. 17. A “view” can be geometrically determined, and be calculated. A picture 201 cut out at the viewing region setting distance by the lines connecting the observer i and both ends of the display 10 coincides with the “view” of the display 10. In the example of FIG. 17, a region 212 in the picture 201 is a region allowing stereoscopic viewing, and a region 213 is a region not allowing stereoscopic viewing. The ratio of the viewing region 212 allowing stereoscopic viewing to the area of the entire region of the picture 201 may be calculated by the second calculator 24 as a second weight wᵢ₂ of the observer i. For example, if the ratio of the viewing region 212 allowing stereoscopic viewing is 100%, the entire region may be stereoscopically viewed, and thus, the value of the second weight wᵢ₂ may be made a maximum value of “1”, for example.

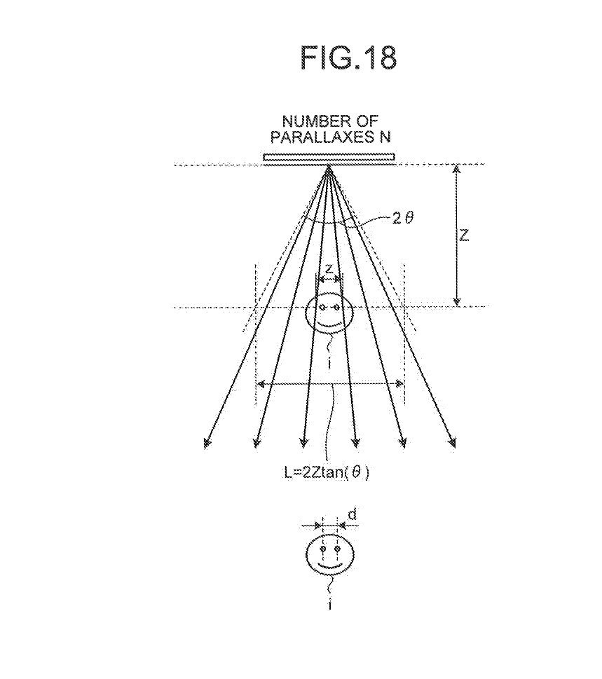

Next, the third weight will be described with reference to FIG. 18. When the number of parallaxes is given as N, the spread of light beams is given as 2θ, the distance from the display 10 to an observer i is given as Z, the distance between the eyes of the observer i is given as d, and the light beam width at the position of the observer i (more specifically, the position of the eyes of the observer) is given as z, a third weight w of the observer i may be expressed by the following Equation (3).

$$\text{?} = \{ \begin{matrix}1 if & z < \frac{dN}{2 tan θ} \\ \frac{d}{L / N} & otherwise\end{matrix} \\ \text{?} \text{indicates text missing or illegible when filed} \qquad ( 3 )$$

Additionally, the L in Equation (3) above may be expressed by the following Equation (4).

L=2Z tan θ (4)

The third weight wᵢ₃ may be calculated according to Equation (3) above. That is the ratio between the light bean width z at the position of the observer i and the distance d between the eyes is taken as the third weight wᵢ₃. In the case the light beam width z is less than the distance d between the eyes, the value of the third weight wᵢ₃ is “1”.

In the manner described above, the second calculator 24 calculates, for each observer, the first weight, the second weight, and the third weight, and determines the product of the first weight, the second weight, and the third weight which have been calculated, to thereby calculate the weight of the observer, but this is not restrictive. For example, the second calculator 24 may calculate, for each observer, only the first weight, and take the calculated first weight as the weight indicating the degree of desirability of stereoscopic viewing of a case where a stereoscopic image according to the display parameter used in the calculation of the first weight is displayed on the display 10.

Alternatively, for example, the second calculator 24 may calculate, for each observer, only the first weight and the second weight, and take the weight based on the first weight and the second weight which have been calculated (the product of the first weight and the second weight) as the weight indicating the degree of desirability of stereoscopic viewing of a case where a stereoscopic image according to the display parameter used in the calculation of the first weight and the second weight is displayed on the display 10. Furthermore, for example, the second calculator 24 may calculate, for each observer, only the first weight, and the third weight, and take the weight based on the first weight and the third weight which have been calculated (the product of the first weight and the third weight) as the weight indicating the degree of desirability of stereoscopic viewing of a case where a stereoscopic image according to the display parameter used in the calculation of the first weight and the third weight is displayed on the display 10.

Referring back to FIG. 6, description will be given. The selector 25 selects one display parameter based on the weight calculated by the second calculator 24. In the present embodiment, the selector 25 selects a display parameter according to which the total sum of the weights of the observers is the greatest. More specifically, the selector 25 selects a display parameter included in the weight information according to which the total sum of the weights is the greatest, among a plurality of pieces of weight information received from the second calculator 24 the same number of pieces of weight information as the plurality of display parameters stored in the storage unit 23). The selector 25 transmits information indicating the selected display parameter to the determiner 25. Additionally, in the present embodiment, the selector 25 selects the display parameter according to which the total sum of the weights of the observers is the greatest, but this is not restrictive, and it is also possible to select a display parameter according to which the product; of the weights of the observers is the greatest.

The determiner 25 determines a stereoscopic image to be displayed on the display 10 according to the display parameter selected by the selector 25. For example, the determiner 26 may correct a stereoscopic image to be displayed which has already been acquired (which has already been generated), according to the display parameter selected by the selector 25, and determine the corrected stereoscopic image as the stereoscopic image to be displayed on the display 10. The determiner 26 transmits the determined stereoscopic image to the output unit 27.

The output unit 27 outputs the stereoscopic image determined by the determiner 26 to the display 10. Additionally, the determined stereoscopic image may be output to the display 10 by the determiner 26, without the output unit 27 being provided, for example.

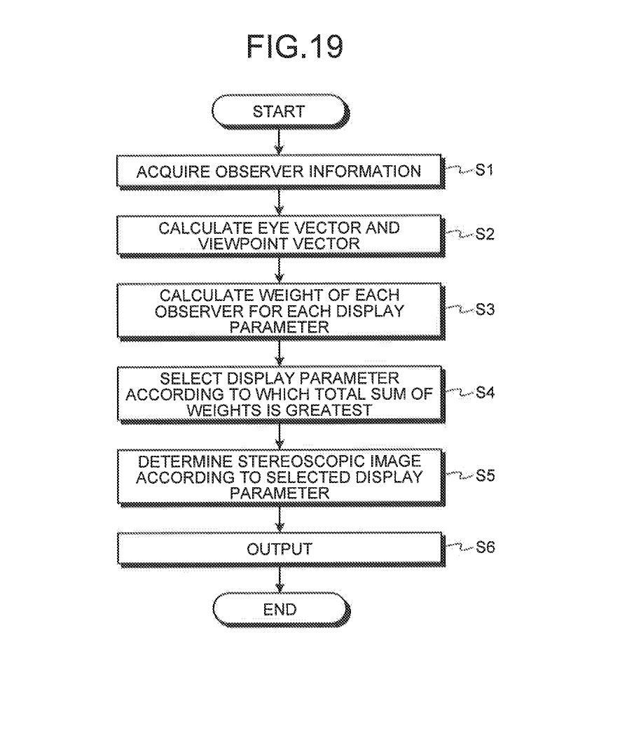

Next, a process of the image processor 20 will be described with reference to FIG. 19. FIG. 19 is a flow chart illustrating an example of a process of the image processor 20. As illustrated in FIG. 19, first, the acquisition unit 21 acquires observer information including position(s) of one or more observers (step S1). Based on the observer information acquired in step S1, the first calculator 22 calculates, for each of one or more observers, the eye vector and the viewpoint vector of the observer (step S2). The first calculator 22 transmits information indicating the eye vector and the viewpoint vector of each observer which have been calculated to the second calculator 24.

The second calculator 24 calculates, for each observer and for each of a plurality of display parameters stored in advance in the storage unit 23, the weight indicating the degree of desirability of stereoscopic viewing of a case where a stereoscopic image according to the display parameter is displayed on the display 10, based on the display parameter and the eye vector and the viewpoint vector of each observer (step S3). Then, the second calculator 24 transmits information associating the calculated weight of each observer and the display parameter used in the calculation of the weight to the selector 25.

The selector 25 selects the display parameter included in the weight information with the greatest total sum of weights, among a plurality of pieces of weight information received from the second calculator 24 (step S4). The selector 25 transmits information indicating the selected display parameter to the determiner 26. The determiner 26 determines the stereoscopic image to be displayed on the display 10, according to the display parameter selected by the selector 25 (step S5). The determiner 26 transmits the determined stereoscopic image to the output unit 27. The output unit 27 out the stereoscopic image determined by the determiner 25 to the display 10 (step S5).

As described, above, in the present embodiment, a weight indicating the degree of desirability of stereoscopic viewing when stereoscopic image according to a display parameter is displayed on the display 10 is calculated for each observer and for each display parameter including a pixel, parameter for variably setting the arrangement of pixels of a stereoscopic image, by using the viewpoint vector (the vector pointing from one to the other of the position of an observer and the display 10) and the eye vector (the vector pointing from one eye to the other eye of the observer) of one or more observers existing around the display 10 which is horizontally placed. Then, a display parameter according to which the total sum of the weights of the observers is the greatest is selected, and a stereoscopic image to be displayed on the display 10 is determined according to the selected display parameter, and thus, a stereoscopic image which can be stereoscopically viewed in a desirable manner by one or more observers existing around the display 10 which is horizontally placed may be provided without any special configuration such as a mirror surface or a wall surface between pixels.

### (1) EXAMPLE MODIFICATION 1

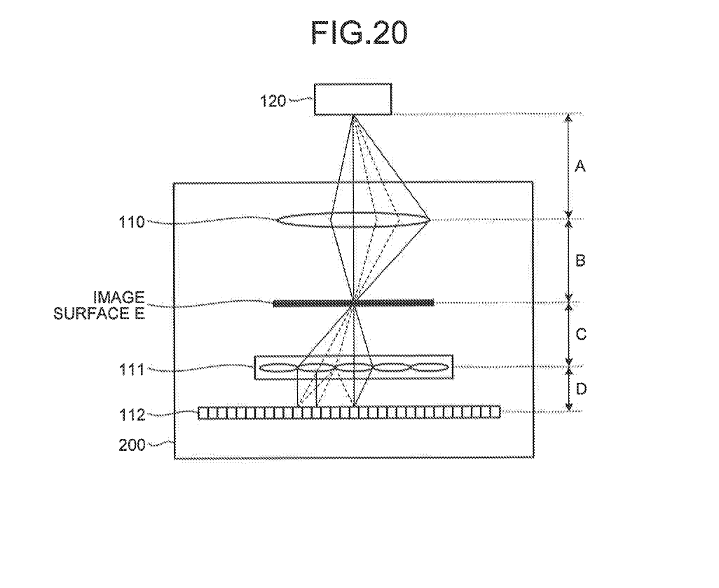

For example, the acquisition unit 21 may include a capturing unit for capturing a compound-eye image formed from a plurality of micro lens images by using a compound-eye camera including main lens and a micro lens array, and an observer information calculator for calculating observer information including the position of an observer by using the compound-eye image. More specific details are as follows. FIG. 20 is a diagram illustrating an example configuration of a capturing unit 200 for capturing a compound-eye image. As illustrated in FIG. 20, the capturing unit 200 includes a capturing optical system including a main lens 110 for imaging the light from a subject 120, a micro lens array 111 where a plurality of micro lenses are arrayed, and an optical sensor 112. In the example in FIG. 20, the main lens 110 is set such that an imaging surface of the main lens 110 is positioned between the main lens 110 and the micro lens array 111 (an image surface E). Although not illustrated, the capturing unit 200 further includes a sensor drive it for driving a sensor. The sensor drive unit is controlled according to a control, signal from outside.

The optical sensor 112 converts light imaged by each micro lens of the micro lens array 111 on a light receiving surface into an electrical, signal, and outputs the signal. As the optical sensor 112, for example, a CCD (Charge Coupled Device) image sensor, a CMOS (Complementary Metal Oxide Semiconductor) image sensor or the like may be used. With these image sensors, light receiving elements corresponding to respective pixels are arranged on a light receiving plane in a matrix, light is converted into an electrical signal of each pixel by photoelectric conversion by each light receiving element, and the signal is output. A compound-eye image formed from a plurality of micro lens images is thereby obtained.

The capturing unit 200 receives light which has entered from a position above the main lens 110 onto a position on the micro lens array 111 by the optical sensor 112, and outputs an image signal (a compound-eye image) including pixel signals of each pixel. The capturing device configured in this manner is known by the name of a light field camera or a Plehoptic camera.

Then, the observer information calculator included in the acquisition unit 21 calculates the position of an observer (calculates observer information) by using the compound-eye image captured by the capturing unit 200. The observer information calculator may calculate the distance to the subject 120 by using the compound-eye image captured by the capturing unit 200 and by union the method described in Full-Resolution. Depth Map Estimation from an Aliased Plenoptic Light Field. by: Tom E. Bishop, and. Paolo Favaro in: ACCV 2, Vol. 6493, Springer (2010), p. 186-200, for example.

### (2) EXAMPLE MODIFICATION 2

Furthermore, the second calculator 24 may calculate the weight indicating the degree of desirability of stereoscopic viewing based on an attribute of an observer. An attribute is information indicating the observation time of an image, the order of start of observation, whether an observer is a specific person or not, whether an observer holds a remote control or not, the positional relationship of persons, or the like. Here, a weight based on the attribute is referred toes a fourth weight. With respect to the observation time or the order of start of observation, the value of the weight is made greater so as to prioritize a long-time observer or an early observation starter.

Similarly, the value of the weight is made greater so as to prioritize a specific person or a remote control holder. With respect to the positional relationship of persons, the value of the weight is made greater for a person in front of the display or a person positioning closer to the front thereof.

For example, the second calculator 24 may calculate, as the fourth weight, the sum or the product of the values of the weights calculated with respect to the observation time, the order of start of observation, whether an observer is a specific person or not, whether an observer holds a remote control or not, the positional relationship of persons, and the like. Then, the weight corresponding to the display parameter is calculated based on the first weight and the fourth weight. Also, the second calculator 24 may calculate the weight corresponding to the display parameter based on the first weight, at least one of the second weight and the third weight, the first weight, and the fourth weight.

The image processor 20 of the embodiment described above has a hardware configuration including a CPU (Central Processing Unit), a ROM, a RAM, a communication I/F device, and the like. The function of each unit described above (the acquisition unit 21, the first calculator 22, the second calculator 24, the selector 25, the determiner 26, and the output unit 27) is realized by the CPU developing a program stored in the ROM on the RAM and executing the program, but this is not restrictive. At least a part of the functions of the units described above may also be realized by a dedicated hardware circuit.

Furthermore, the program to be executed by the image processor 20 of the embodiment described above may be provided by storing the program or a computer connected to a network such as the Internet, and downloading the program via the network. Also, the program to be executed by the image processor 20 of the embodiment described above may be provided or distributed via a network such as the Internet. Moreover, the program to be executed by the image processor of the embodiment described above may be provided by being embedded in advance in a non-volatile recording medium such as the ROM.

While certain embodiments have been described, these embodiments have been presented by way of example only, and are not intended to limit, the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device that provides a stereoscopic image to he displayed on a display, the device comprising:
an acquisition unit configured to acquire observer information including a position o at least one observer;
a first calculator configured to calculate, a viewpoint vector pointing from one to another of the position of each observer and the display, and an eye vector pointing from one eye to another eye of the observer, basest on the observer information;
a second calculator configured to calculate a weight indicating a degree of desirability of stereoscopic viewing for each observer when the stereoscopic image according to one of display parameters is displayed on the display, by using the viewpoint vector and the eye vector of the observer;
a selector configured to select one of the display parameters based on the weight; and
a determiner configured to determine the stereoscopic image according to the selected display parameter.

2. The device according to claim 1, wherein the selector selects the display parameter according to which a total sum of the weights is greatest.

3. The device according to claim. 2 wherein the weight takes a greater value in a case a first relationship and a second relationship satisfy a specific condition than in a case where the specific condition is not satisfied, the first relationship being a relationship of a direction of the viewpoint vector and a direction of a vertical vector indicating a vertical direction of a parallax image included in the stereographic image, and the second relationship being a relationship of a direction of a parallax vector and a direction of the eye vector, the parallax vector indicating an amount of parallax between the parallax images.

4. The device according to claim 3 wherein
the display is placed such that an image display plane of the display, on which the stereoscopic image is displayed, is parallel to a horizontal plane, and
the specific condition is satisfied when a product of a first inner product and a second inner product takes a positive value, the first inner product indicating an inner product of the viewpoint vector pointing from a position of the observer to the display where an upward direction on the horizontal plane is positive and the vertical vector indicating an upward direction of the parallax image Where an upward direction on the horizontal plane is positive, the second inner product indicating an inner product of the parallax vector indicating the amount of parallax between the parallax image corresponding so a left eye of the observer and the parallax image corresponding to a right eye of the observer where the parallax image corresponding to the left eye of the observer is taken as a reference and where a direction from right to left on the horizontal plane is positive and the eye vector pointing from the right eye of the observer to the left eye where a direction from right to left on the horizontal plane is positive.

5. The device according to claim 4, wherein a value of the weight is a value according to the product of the first inner product and the second inner product.

6. The device according to claim 5, wherein the second calculator calculates, for each observer, a first weight according to the product of the first inner product and the second inner product, and a second weight according to an area of a region allowing stereoscopic viewing at a position of the observer, and calculates the weight of the observer based on the first weight and the second weight.

7. The device according to claim 5, wherein the second calculator calculates, for each observer, the first weight according to the product of the first inner product and the second inner product, and a third weight according to a density of light beams emitted from the display at the position of the observer, and calculates the weight of the observer based on the first weight and the third weight.

8. The device according to claim 1, wherein the display parameter includes a pixel parameter for variably setting an arrangement of pixels of the stereoscopic image to be displayed on the display.

9. The device according to claim 1, wherein the acquisition unit includes
a capturing unit configured to capture a compound-eye image formed from a plurality of micro lens images, by using a compound-eye camera including a main lens and a micro lens array, and
an observer information calculator configured to calculate the observer information by using the compound-eye image.

10. An image processing method comprising:
acquiring observer information including a position of at least one observer;
calculating, a viewpoint vector pointing from one to another of the position of each observer and a display that displays a stereoscopic image, and an eye vector pointing from one eye to another eye of the observer, based on the observer information;
calculating a weight indicating a degree of desirability of stereoscopic viewing for each observer when the stereoscopic image according to one of the display parameters is displayed on the display, h using the viewpoint vector and the eye vector of the observer;
selecting one of the display parameters based on the weight; and
determining the stereoscopic image to be displayed on the display, according to tee selected display parameter.

11. A stereoscopic image display device comprising:
a display configured to display a stereoscopic image;
an acquisition unit configured to acquire observer information including a position of at least one observer;
a first calculator configured to calculate, a viewpoint vector pointing from one to another of the position of each observer and the display, and an eye vector pointing from one eye to another eye of the observer, based on the observer information;
a second calculator configured to calculate a weight indicating a degree of desirability of stereoscopic viewing for each observer when the stereoscopic image according to one of display parameters is displayed on the display, by using the viewpoint vector and the eye vector of the observer;
a selector configured to select one of the display parameters based on the weight; and
a determiner configured to determine the stereoscopic image according to the selected display parameter.

12. The device according to claim 11, wherein the selector selects the display parameter according to which a total sum of the weights is greatest.

13. The device according to claim 12, wherein the weight takes a greater value in a case a first relationship and a second relationship satisfy a specific condition, than in a case where the specific condition is not satisfied, the first relationship being a relationship of a direction of the viewpoint vector and a direction of a vertical vector indicating a vertical direction of a parallax image included in the stereographic image, and the second relationship being a relationship of a direction of a parallax vector and a direction of the eye vector, the parallax vector indicating an amount of parallax between the parallax images.

14. The device according to claim 13 wherein
the display is placed such that an image display plane oil the display, on which the stereoscopic image is displayed, is parallel to a horizontal plane, and
the specific condition is satisfied when a product of a first inner product and a second inner product takes a positive value, the first inner product indicating an inner product of the viewpoint vector pointing from a position of the observer to the display where an upward direction on the horizontal plane is positive and the vertical vector indicating an upward direction of the parallax image where an upward direction on the horizontal plane is positive, the second inner product indicating an inner product of the parallax vector indicating the amount of parallax between the parallax image corresponding to a left eye of the observer and the parallax image corresponding to a right eye of the observer where the parallax image corresponding to the left eye of the observer is taken as a reference and where a direction from right to left on the horizontal plane is positive and the eye vector pointing from the right eye of the observer to the left eye where a direction from right to left on the horizontal plane is positive.

15. The device according to claim 14, wherein a value of the weight is a value according to the product of the first inner product and the second inner product.

16. The device according to claim 15, wherein the second calculator calculates, for each observer, a first weight according to the product of the first inner product and the second inner product, and a second weight according to an area of a region allowing stereoscopic viewing at a position of the observer, and calculates the weight of the observer based on the first weight and the second weight.

17. The device according to claim 15, wherein the second calculator calculates, for each observer, the first weight according to the product of the first inner product and the second inner product, and a third weight according to a density of light beams emitted from the display at the position of the observer, and calculates the weight of the observer based on the first weight and the third weight.

18. The device according to claim 11, wherein the display parameter includes a pixel parameter for variably setting an arrangement of pixels of the stereoscopic image to be displayed on the display.

19. The device according to claim 11, wherein the acquisition unit includes
a capturing unit configured to capture a compound-eye image formed from a plurality of micro lens images, by using a compound-eye camera including a main lens and a micro lens array, and
an observer information calculator configured to calculate the observer information by using the compound-eye image.
